(19) United States
(12) Patent Application Publication
(10) Pub. No.: US 2008/0237242 A1
(43) Pub. Date: Oct. 2, 2008

(54) Insulated holder with fluid container opener

(76) Inventor: Ronald C. Gifford, Ocean City, NJ (US)

Correspondence Address: HOLLSTEIN KEATING CATTELL JOHNSON & GOLDSTEIN P.C., WILLOW RIDGE EXECUTIVE OFFICE PARK, 750 ROUTE 73 SOUTH, SUITE 301, MARLTON, NJ, 08053, US

(21) Appl. No.: 11/732,072

(22) Filed: Apr. 2, 2007

(51) Int. Cl. A47J 41/00

(52) U.S. Cl. 220/592.16

(57) ABSTRACT

A jacket type, insulated fluid container holder is formed as a sleeve having two open ends. The sleeve is configured to slide onto a fluid container, such as a bottle of beer, soda, ice tea, or the like. A separable, independent disc shaped base member is designed to be inserted into either of the open ends of the sleeve to provide additional support for the container located within the sleeve. The base member has a bottle opener integrally formed within its outer surface. When removed and separated from the sleeve, the bottle opener on the base member can be used to detach the cap from the fluid container. The base member is then returned to one of the ends of the sleeve and the container slid into the sleeve. The base member can also be permanently attached to one end of the sleeve and its bottle opener used to detach caps in this configuration as well.

### BACKGROUND OF THE INVENTION

Insulated jacket type fluid container holders, generally known as “koozies”, are used for maintaining the temperature of drinking fluid in a can, bottle, glass, mug or similar drinking fluid container. Such holders are designed to keep fluids in the container cold or hot, while still allowing the user to comfortably carry the holder. They usually take the shape of cylindrical, open ended sleeves made of foam, neoprene or similar lightweight resiliently compressible, insulating material. The sleeves conveniently slide onto the bottle, can, or other fluid receptacle. The compressible nature of the sleeve permits use of the holder on a number of different sized containers.

However, despite the fact that the holder is designed to retain a container, the holder's end openings still make the container susceptible to it sliding out of the holder. This is especially the case with cold bottles and cans which often have condensation on their exterior surfaces, making them slippery.

A logistical problem also often arises during the use of such insulated container holders, when the drinker obtains an unopened, capped bottle of soda, beer, ice tea, or similar bottled drink. Although many such bottles have twist-off caps, many do not and a bottle opener is needed. It is not a rare occurrence that an opener is not available and must be located. It would be a great convenience if an opener was readily available for use.

### SUMMARY OF THE INVENTION

It is thus an object of the present invention to provide a new and improved insulated holder for drinking fluid containers which is equipped with a base for supporting a container and a readily available container opener which can be used immediately to open a container when the holder itself is to be used.

These and other objects are accomplished by present invention, a jacket type, insulated fluid container holder comprising a sleeve having two open ends. The sleeve is configured to slide onto a fluid container, such as a bottle of beer, soda, ice tea, or the like. A separable, independent disc shaped base member is designed to be inserted into either of the open ends of the sleeve to provide additional support for the container located within the sleeve. The base member has a bottle opener integrally formed within its outer surface. When removed and separated from the sleeve, the bottle opener on the base member can be used to detach the cap from the fluid container. The base member is then returned to one of the ends of the sleeve and the container slid into the sleeve. The base member can also be permanently attached to one end of the sleeve and its bottle opener used to detach caps in this configuration as well.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the insulated holder of the present invention, showing the bottom of the holder with its base member inserted therein.

FIG. 2 is an isometric view of the insulated holder of the present invention, showing the top of the holder with its base member inserted therein.

FIG. 3 is the bottom view of the insulated holder of the present invention.

FIG. 4 is the top view of the insulated holder of the present invention.

FIG. 5 is an elevation view of the insulated holder of the present invention with its base member inserted therein.

FIG. 6 is an isometric view of the insulated holder of the present invention with its components separated.

FIG. 7 is an elevation view of the insulated holder of the present invention with its components separated.

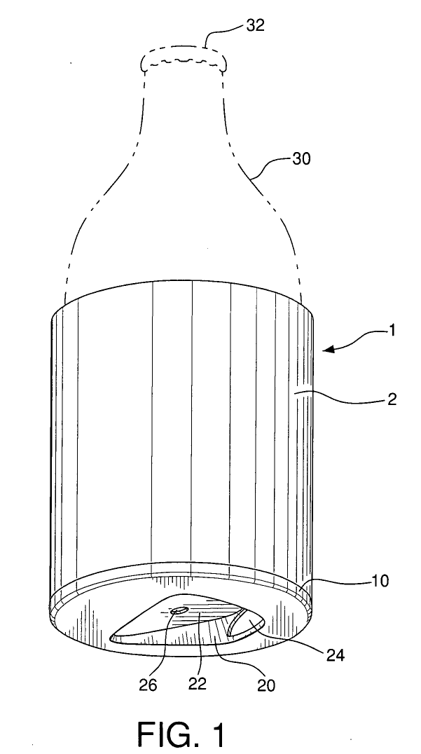

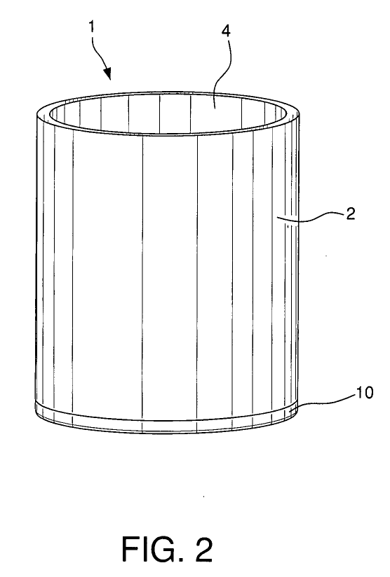

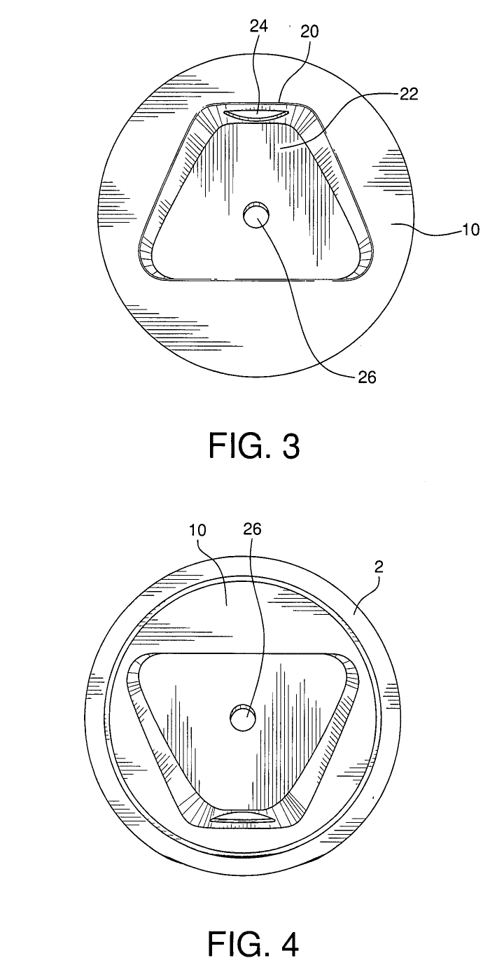

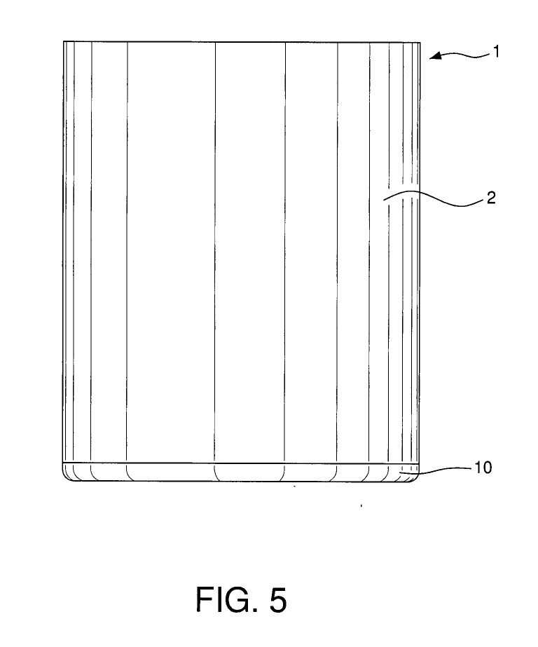

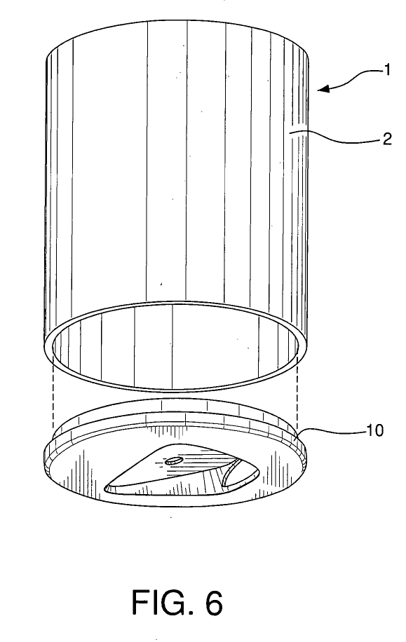

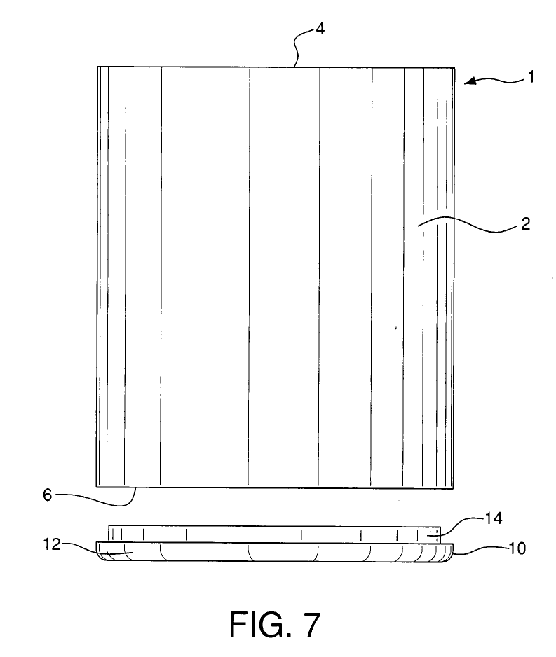

### DETAILED DESCRIPTION OF THE INVENTION

Container holder 1 of the present invention comprises cylindrically shaped sleeve member 2 made of foam, neoprene or similar resiliently compressible, lightweight insulating material. Sleeve member 2 is a through sleeve with openings 4 and 6, configured to slideably accept a fluid beverage container, such as a can or bottle 30.

Container holder 1 also comprises a separate, independent holder base 10 made of hard molded plastic or similar rigid, lightweight material. Base 10 is disc shaped, comprising first section 12 of a first diameter and second section 14 of a smaller diameter. Section 14 is configured to be inserted into either opening 4 and 6 and is sized to fit snugly within that opening. Integrally formed within base 10 is bottle opener 20 comprising indented space 22 and tab member 24. Through hole 26 is located with base 10.

In use, base 10 is sized to fit within one of the openings 4 or 6. Base 10 can be permanently attached to and secured within one of the openings 4 or 6 by glue, epoxy, or similar, equivalent means. In the alternative, base 10 can be a separate element which fits snugly within one of the openings 4 or 6 and is removeable from the openings. Through hole 26 makes it easy to pull and remove base 10, separating it from sleeve member 2. Whether base 10 is secured to sleeve 2 within opening 4 or 6 or whether it is separated from the sleeve, opener 20 is used to detach bottle cap 32 from bottle or similar fluid container 30. No other outside opener need be located and retrieved. After opening container 30, base 10, if in its removeable state, is again inserted into either opening 4 or 6, where it snugly fits within sleeve member 2. Container 30 is then slideably inserted into the other opening of sleeve member 2, where it is supported by both the resilient, compression pressure of the foam-like material of the encompassing sleeve and by base 10. Through hole 26 acts as a vent for exiting air as container 30 is slid into sleeve 2. The result is a container holder 1 which not only serves to insulate the fluid within a container, but also firmly supports the container within the holder.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. An insulated container holder for a fluid container with a detachable cap, said holder comprising:
elongated sleeve means for retaining the fluid container and maintaining the temperature of fluid in the fluid container, said sleeve means substantially encompassing the fluid container and having two open ends; and
a separable, unitary container holder base comprising fluid container opener means for removing the detachable cap of the fluid container, said base being removal from the sleeve means and being configured to be positioned within either of the two open ends to close off that open end, whereby when the base is in position within one of the two ends it assists in supporting the fluid container within the sleeve means and when the base is removed from the sleeve means, the opener means of the base is used to remove the detachable cap.

2. The holder as in claim 1 wherein the sleeve means is substantially cylindrical.

3. The holder as in claim 1 wherein the open ends are substantially circular.

4. The holder as in claim 1 wherein the opener means is a bottle opener.

5. The holder as in claim 1 wherein the opener means is a container opener for a fluid container.

6. The holder as in claim 1 wherein said base is disc shape and is sized to snuggly fit in and be removeable from either of the two open ends.

7. The holder as in claim 1 wherein the base comprises a first section insertable into either end of the sleeve means, and a second section in which the opener means is formed.

8. The holder as in claim 1 wherein the base comprises a through hole.

9. An insulated container holder for a fluid container with a detachable cap, said holder comprising:
elongated sleeve means for retaining the fluid container and maintaining the temperature of fluid in the fluid container, said sleeve means substantially encompassing the fluid container and having two open ends; and
a unitary container holder base comprising fluid container opener means for removing the detachable cap of the fluid container, said base being positioned within either of the two open ends to close off that open end, whereby when the base is in position within one of the two ends it assists in supporting the fluid container within the sleeve means.

10. The holder as in claim 9 wherein the sleeve means is substantially cylindrical.

11. The holder as in claim 9 wherein the open ends are substantially circular.

12. The holder as in claim 9 wherein the opener means is a bottle opener.

13. The holder as in claim 9 wherein the opener means is a container opener for a fluid container.

14. The holder as in claim 9 wherein said base is disc shape and is sized to snuggly fit in and be removeable from either of the two open ends.

15. The holder as in claim 9 wherein the base is disc shape and is sized to snuggly fit in and be attached to either of the two open ends.

16. The holder as in claim 9 wherein the base comprises a first section insertable into either end of the sleeve means, and a second section in which the opener means is formed.

17. The holder as in claim 9 wherein the base comprises a through hole.
